(19) United States
(12) Patent Application Publication
(10) Pub. No.: US 2007/0063382 A1
(43) Pub. Date: Mar. 22, 2007

(54) Mold quick disconnect apparatus

(76) Inventor: Larry Cole, Garland, TX (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/522,778

(22) Filed: Sep. 18, 2006

Related U.S. Application Data
(60) Provisional application No. 60/718,144, filed on Sep. 16, 2005.

(51) Int. Cl. B28B 1/02

(52) U.S. Cl. 264/310; 425/425

(57) ABSTRACT

A quick disconnect apparatus is shown for rapid changing of molds, spiders and grates on a machine arm of a rotational molding machine. A base plate is attached to the rotational arm of the rotational molding machine. A cooperating locking plate is attached to the mold, spider or other device to be mounted on the rotational arm. The locking plate engages the base plate by means of a slide mechanism which can be operated by tightening a single bolt. The slide mechanism includes a sliding plate which engage upstanding pins on the base plate.

The present application claims priority in U.S. Provisional Patent Application Ser. No. 60/718,144 filed Sep. 16, 2005 and entitled “Mold Quick Disconnect Apparatus”

### BACKGROUND OF THE INVENTION

1. Field of the Invention

The present invention relates generally to a device for enabling rapid changing of molds, spiders and related equipment on the machine arm of a rotational molding machine.

2. Description of the Prior Art

Rotational molding is a manufacturing technique which will be familiar to those skilled in the relevant arts. Basically, in rotational molding, the product is formed inside a closed mold or cavity where the mold is rotated by biaxially in a heating chamber. To obtain the mold rotation in two planes perpendicular to each other, a spindle is rotated on a primary axis, while the mold is rotated on a secondary axis. In the loading stage, either liquid or powdered plastic is charged into a hollow mold. The mold halves are then clamped shut and then moved into an oven where the loaded mold spins biaxially.

In the oven, heat penetrates the mold causing the plastic, if it is in the powder form, to become tacky and stick to the mold surface, or if it is in the liquid form, to start to gel. Usually, the heating is done by air or liquid or high specific heat, such as molting salt. Since the mold continues to rotate while the heating is going on, the plastic will gradually become distributed evenly on the mold cavity walls through gravitational force. As the cycle continues, the synthetic material melts completely and forms a homogeneous layer of molten plastic.

When the parts have been formed, the mold is moved to a cooling chamber where cooling is accomplished by either a cold spray of water and/or forced air or liquid circulation inside the mold.

The mold continues to be rotated during the cooling cycle. Additional details on rotational molding can be found in the Plastic Engineering Handbook of the Society of Plastics, Inc., 4^{th} Ed. J. Frados, Nostrand-Reinhold Publishers, and similar references.

A rotational molding cycle therefore includes the steps of bringing together two or more mold parts to form a mold having a cavity in which an article may be cast, placing particulate material inside the mold, heating the mold until the material inside is melted, rotating the mold about several different axes so that the entire cavity surface is coated with the melted material and then allowing the mold to cool so that the melted material hardens and forms an article. Rotation about several axis is accomplished by securing the mold to a suitable apparatus which can facilitate the required movement. This apparatus will be referred to as the “machine arm” in the discussion which follows.

Each step in a molding cycle requires a finite amount of time and process efficiency is generally measured by the number of articles which can be formed in a given period which is directly related to the duration of the cycle. To increase process efficiency, the industry has designed various mold apparatus which can form several articles during a single cycle period. The most common multi-mold apparatus include several molds which are mounted to a “spider” system. The spider wheel system is secured to a multi-articulate machine and the heating, rotating and cooling steps described above are performed. The apparatus of the invention has application to both individual molds as well as to spiders containing a varied number of molds.

It is periodically necessary to change out individual molds or spiders on the machine arm of a rotational molding machine of the above type. The change out activity obviously extends the molding cycle and can be a time consuming and labor intensive activity which is therefore expensive. There are a number of examples of prior art devices which allow replacement of molds on rotational molding machines. For example, U.S. Pat. No. 6,267,917, issued Jul. 31, 2001, to Guzikowski et al., shows a mold apparatus for facilitating replacement of rotatable molds contained therein. First and second frames are provided forming a plurality of mold cells and each mold includes an upper and a lower mold section. The upper mold section is removably coupled to the upper frame, while the lower mold section is removably coupled to the lower frame. Using this arrangement, a mold may be removed by detaching all connections between it and the frames, while maintaining the frames closed. Similarly, a mold may be inserted into a mold cell and connected to the frames while maintaining the frames closed. The removal and insertion operations may be performed radially or axially, depending on frame configuration.

While devices of the above type have obviously found application in the industry, they tend to be overly complicated, expensive to produce and time consuming to operate.

A need exists, therefore, for a mold quick-release which is simple in design and economical to manufacture and which facilitates easy replacement of a mold or a spider in a rotational molding system of the type described.

### SUMMARY OF THE INVENTION

The present invention provides a new system to rapidly mount single molds, multi-cavity spiders, and related equipment such as universal grate spiders to the machine arm of a rotational molding machine. The new system provides rapid mold and spider changes and also provides the advantage of allowing the operator to work off-line on complex tools that require extensive servicing and attention.

The system of the invention is particularly well adapted for facilitating replacement of rotatable molds on a rotational molding machine having a machine arm. The apparatus which is used in the system of the invention includes a base plate securable to the machine arm of the rotational molding machine. A mold plate is securable to a mold which is to be attached to the rotational molding machine. A locking means is cooperatively associated with the base plate and mold plate for releasably securing the base plate and mold plate so that the mold is thereby secured to the arm of the rotational molding machine. The locking means includes a plurality of upstanding pins on the base plate and a sliding wedge element carried in a slot on the mold plate. The mold plate also has at least one aperture for receiving the upstanding pins on the base plate when the mold plate is stacked atop the base plate. The wedge element is movable between an unlocked position in the mold plate slot and a locked position by means of a single drive bolt to engage and disengage the wedge element from the upstanding pins on the base plate.

Additional objects, features and advantages will be apparent in the written description which follows.

### BRIEF DESCRIPTION OF THE DRAWINGS

FIG. 1 is an exploded view of the base plate and mold plate of the invention showing the base plate attached to the machine arm of a rotational molding machine.

FIG. 2 is an isolated view of the base plate of the apparatus of the invention.

FIG. 3 is an isolated, perspective view of the mold plate of the invention.

FIG. 4 is a plan view of the mold plate of FIG. 3, showing the tapered wedge element carried thereon.

FIG. 5 is a perspective view of the assembled base plate and mold plate used in the system of the invention.

### DETAILED DESCRIPTION OF THE INVENTION

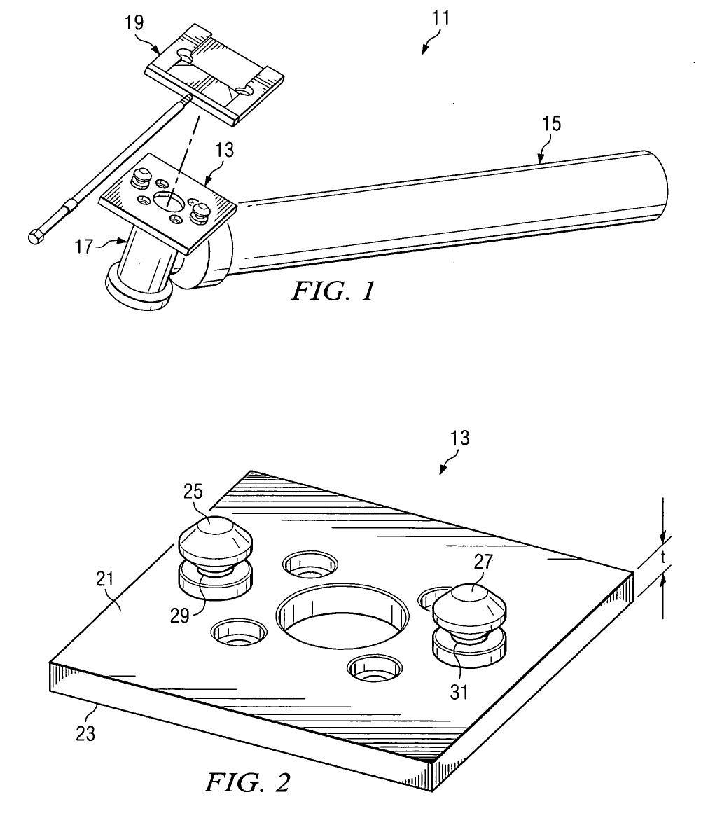

Turning to FIG. 1, there is shown a mold apparatus of the invention for facilitating the replacement of rotatable molds on a rotational molding machine having a machine arm. The mold apparatus, designated generally as 11 , includes a base plate 13 which is shown mounted on the machine arm 15 of the rotational molding machine (not shown) and support element 17. The apparatus of the invention also includes a mold plate 19 which is securable to a mold (not shown) which is to be attached to the rotational molding machine.

As best seen in FIG. 2, the base plate 13 has upper and lower planar surfaces 21,23 separated by a thickness “t.” The base plate 13 carries a part of a locking means cooperatively associated with the base plate 13 and the mold plate 19 for releasably securing the base plate and mold plate so that the mold is thereby secured to the arm of the rotational molding machine. No particular form of the mold is illustrated in the drawings since any of a large variety of molds of various sizes and shapes could be utilized including individual molds or spiders containing a varied number of molds. These might generally range in size from, for example, 2′×2′×1″ to as much as 120″ in diameter with 10 to 20 molds mounted thereon, etc. The molds could be attached to the mold plate 19, for example, by welding, bolting, clamping, etc.

In the embodiment illustrated, the particular locking means carried on the base plate 13 comprises two upstanding pins 25,27 which extend generally vertically upward from the upper planar surface 21 of the base plate 13. It will noted that each upstanding pin 25,27 includes a circumferential wedge element receiving surface 29,31.

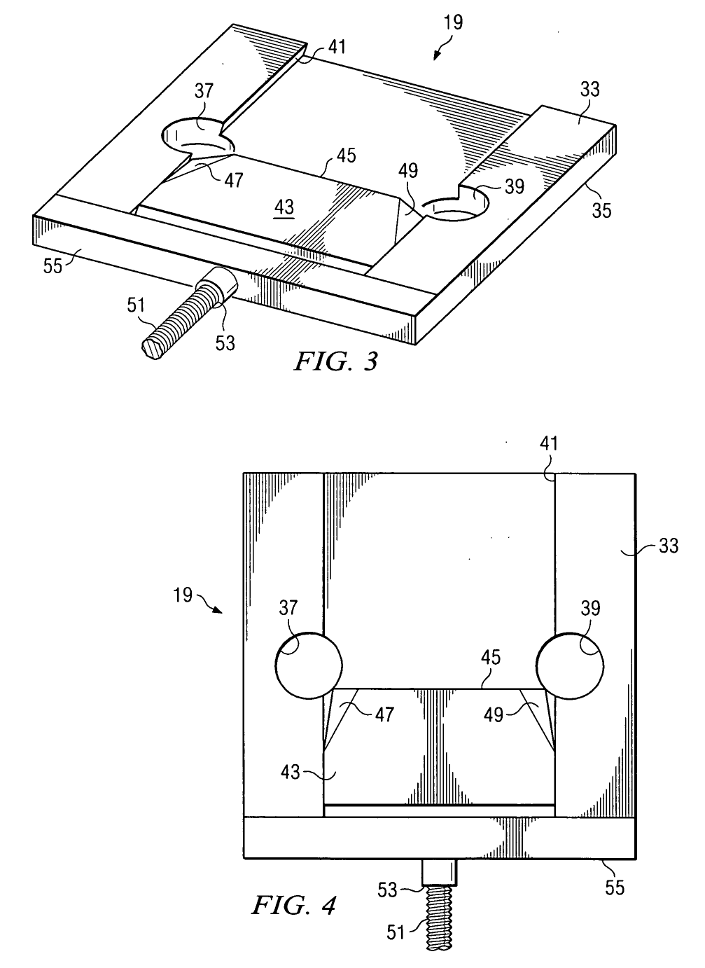

FIGS. 3 and 4 illustrate the mold plate 19 in greater detail. The mold plate 19 is also a planar member having an upper planar surface 33 and a lower planar surface 35. As perhaps can best be appreciated from FIG. 4, the upper planar surface 33 has a pair apertured openings 37,39, which are adapted to align with and receive the upstanding pins 25,27 of the base plate 13 when the mold plate is stacked atop the base plate. The mold plate 19 also includes a slot 41 for slidably receiving a planar wedge element 43. The wedge element 43 is a generally planar plate-like member which includes a flat edge 45 and tapered side edges 47,49. The wedge element 43 is movable between an unlocked position in the mold plate slot 41 and a locked position by means of a single threaded drive bolt 51 to engage and disengage the wedge element from the upstanding pins 25,27 on the base plate 13. The drive bolt 51 includes a threaded shaft which is received within a threaded opening 53 provided on a rear wall 55 of the mold plate.

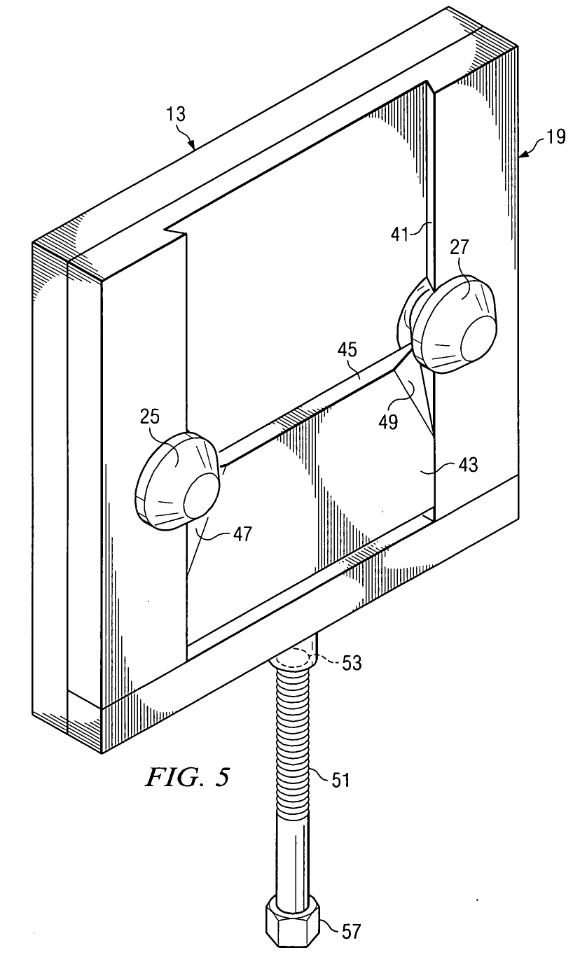

FIG. 5 illustrates the assembled base plate 13 and mold plate 19. In use, the particular mold of interest is first secured to the mold plate 19. As mentioned, this may be a single mold or a spider incorporating a plurality of different mold elements. Typically, a chain hoist will be used to lift the mold plate and associated mold elements and to place the mold plate atop the base plate 13 with the upstanding pins 25,27 aligned and received within the apertured openings 37,39 of the mold plate.

A hydraulic wrench would then typically be mounted on the hex head nut (57 in FIG. 5) of the drive bolt 51 and used to turn the drive bolt within the threaded opening 53 to thereby drive the wedge element 43 in the direction of the upstanding pins 25,27. The tapered side edges 47,49 of the wedge element 43 engage within the wedge element receiving surfaces 29,31 of the upstanding pins 25,27 to thereby releasably lock the base plate and pin plate together. The operation is simply reversed in order to release the mold plate from the pin plate.

An invention has been provided with several advantages. An individual mold or spider can be quickly and easily mounted on the base plate of the invention by the cooperative locking means located on the base plate and mold plate. It is only necessary to lock the plate together by tightening one bolt with a hydraulic wrench. Similarly, the plates can be detached by simply loosening the threaded bolt. This process simplifies the operation of changing molds and spiders within a rotational molding machine, thereby shortening the work cycle otherwise required. The result is a less time consuming and thus less expensive operation. While the invention has been shown in only one of its forms, it is not thus limited but is susceptible to various changes and modifications without departing from the spirit thereof.

What is claimed is:

1. A mold apparatus for facilitating replacement of rotatable molds on a rotational molding machine having a machine arm, the apparatus comprising:
a base plate securable to the machine arm of the rotational molding machine;
a mold plate securable to a mold which is to be attached to the rotational molding machine;
locking means cooperatively associated with the base plate and mold plate for releasably securing the base plate and mold plate so that the mold is thereby secured to the arm of the rotational molding machine; and
wherein the locking means includes a plurality of upstanding pins on the base plate and a sliding wedge element carried in a slot on the mold plate, the mold plate also having at least one aperture for receiving the upstanding pins on the base plate when the mold plate is stacked atop the base plate, the wedge element being movable between an unlocked position in the mold plate slot and a locked position by means of a single drive bolt to engage and disengage the wedge element from the upstanding pins on the base plate.

2. The mold apparatus of claim 1, wherein the mold plate has a generally planar upper surface, and wherein the wedge element is a generally planar element which is carried in a pair of slots located on the mold plate planar upper surface.

3. The mold apparatus of claim 2, wherein the upstanding pins on the base plate are provided with circumferential grooves along the lengths thereof which form wedge receiving surfaces for locking the wedge in engagement with the upstanding pins, thereby locking the base plate and the mold plate together.

4. The mold apparatus of claim 3, wherein the wedge element has a leading edge which faces the upstanding pins when the mold plate is in place on the base plate, and a trailing edge, and wherein the drive bolt has an outer extent which contacts the trailing edge of the wedge element to move the wedge element back and forth in reciprocal fashion within the slots on the upper surface of the mold plate to thereby move the wedge element between the locked and unlocked positions.

5. The mold apparatus of claim 4, wherein the drive bolt can be engaged with the mold plate for securing the mold plate to the base plate, and then disengaged from the mold plate.

6. A method for easily and quickly replacing a rotatable mold on a rotational molding machine having a machine arm, the method comprising the steps of:
providing a base plate and securing the base plate to the machine arm of the rotational molding machine;
attaching a mold plate to a mold which is desired to be attached to the rotational molding machine;
providing locking means cooperatively associated with the base plate and mold plate for releasably securing the base plate and mold plate so that the mold is thereby secured to the arm of the rotational molding machine;
wherein the locking means includes a plurality of upstanding pins on the base plate and a sliding wedge element carried in a slot on the mold plate, the mold plate also having at least one aperture for receiving the upstanding pins on the base plate when the mold plate is stacked atop the base plate, the wedge element being movable between an unlocked position in the mold plate slot and a locked position by means of a single drive bolt to engage and disengage the wedge element from the upstanding pins on the base plate; and placing the mold plate atop the base plate and rotating the drive bolt to drive the wedge element in the direction of the upstanding pins, to thereby contact the pins and secure the mold plate temporarily to the base plate.

7. The method of claim 6, wherein the mold plate has a generally planar upper surface, and wherein the wedge element is a generally planar element which is carried in a pair of slots located on the mold plate planar upper surface.

8. The method of claim 7, wherein the upstanding pins on the base plate are provided with circumferential grooves along the lengths thereof which form wedge receiving surfaces for locking the wedge element in engagement with the upstanding pins, thereby locking the base plate and the mold plate together.

9. The method of claim 8, wherein the wedge element has a leading edge which faces the upstanding pins when the mold plate is in place on the base plate, and a trailing edge, and wherein the drive bolt has an outer extent which contacts the trailing edge of the wedge element to move the wedge element back and forth in reciprocal fashion within the slots on the upper surface of the mold plate to thereby move the wedge element between the locked and unlocked positions.

10. The method of claim 9, wherein the wedge element is a trapezoidal-shaped planar member when viewed from above in isolated fashion.

11. The method of claim 6, further comprising the steps of:
disengaging the mold plate from the base plate by rotating the drive screw in an opposite relative direction to thereby retract the wedge element relative to the upstanding pins, followed by removing the mold plate from the base plate by lifting the mold plate vertically relative to the base plate.
